(19) United States
(12) Patent Application Publication
(10) Pub. No.: US 2005/0257135 A1
(43) Pub. Date: Nov. 17, 2005

(54) Computer generated report comprised of names, text descriptions, and selected parametric values of designated text data objects listed on data tables

(76) Inventor: Robert Listou, Washington, DC (US)

Correspondence Address: Robert Listou, 725 3rd St SW, Washington, DC, 20024, US

(21) Appl. No.: 10/846,247

(22) Filed: May 14, 2004

(51) Int. Cl. G06F 17/00

(52) U.S. Cl. 715/509; 715/503

(57) ABSTRACT

An apparatus, method and article of manufacture of the present invention provides computer-produced reports comprised of data drawn in a user-specified order from designated records of text data objects listed on a data table. The user also specifies the order in which selected parametric values of said objects are to be displayed. The computer then prints, in the specified order, each object name followed by its values of selected parameters.

### CROSS-REFERENCE TO RELATED APPLICATIONS AND PATENTS

U.S. Utility patent application Ser. No. 10/443,364

U.S. Pat. No, 6,134,564

U.S. Pat. No. 6,216,139

### BACKGROUND OF THE INVENTION

This invention relates to the field of data processing, particularly to computer-implemented methods for editing and printing data imaged on tables of text data objects. The present invention provides a new method of editing such data and generating a new type report.

Tables displaying a plurality of text data objects are commonly used two ways. One is selecting objects on a table, the computer records for which can be read and, if desired, printed. In the second use, such tables are the focus of an analysis of all of the listed objects, either on a computer monitor or a printed report. If this second method involves a table of non-homogeneous objects, such as items of evidence in fact investigations in law, the user mentally develops a logical argument, a rational line of thought, that links selected text data objects in chain-like fashion. Current report generation techniques that enable printing of either individual records or complete tables, do not enable direct documenting of such arguments. The present invention meets that need, as an improvement to the inventions referenced herein. Also, while studying a data table the user may wish to edit a parametric value, and the present invention permits that without closing the data table.

U.S. Pat. No. 6,134,564, issued to the present inventor, depicts (in FIG. 9) a dialog box into which the user enters data for the computer record of a particular text data object that is to be listed on a data table. A similar dialog box is depicted in a drawing accompanying this application. In both cases, the dialog box includes one field, titled Description, that has no expressed limitation to the amount of text entered into the computer record of that field. The object of that field is to enable the user of a data table to have immediately available more documented information about an object on the table than its name and parametric values. A click on the name of an object signals the computer to image the dialog box used to create its record, so the user can read the content of the description field. However, including that content in documentation of an argument requires copying the text to a document either manually or using a second computer application. The present invention removes that requirement.

### BRIEF SUMMARY

The object of the present invention is to expand printing limitations associated with current computer-generated data tables, which enable the printing of either the computer record of an individual text data object or an entire table. The object of the present invention is to enable the design and generation of a single report comprised of selected data fields in records of designated objects listed on the data table.

### BRIEF DESCRIPTION OF THE DRAWINGS

FIG. 1 is a data table (100) that lists non-homogeneous text data objects, of which meaningful groups of parameter values, such as those generated by automated sorting in embodiments of U.S. Pat. No. 6,134,564, have little or no importance.

FIG. 2 is an illustration of the type of dialog box (200), such as in embodiments of U.S. Pat. No. 6,216,139, that are used to create for a text data object a computer record that can contain a large amount of text data in addition to parametric values.

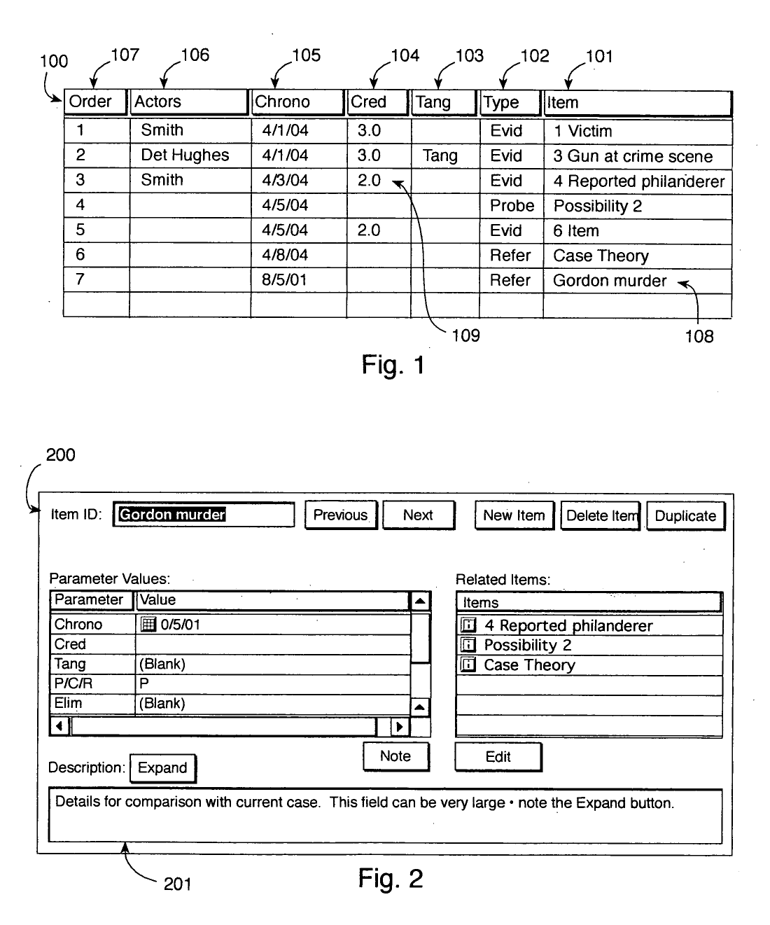

### DETAILED DESCRIPTION OF THE INVENTION

Illustrated by the drawings are two dialog boxes used to create and print a new type of report comprised of selected data of designated text data objects. The illustration uses an investigation in law. A plurality of items of evidence has been documented as text data objects, herein called items, on a data table (100). Identification of the items is in the last column (101). Each item is categorized according to type (102), i.e. evidence, a probe (inquiry), or a reference. Those items that are tangible are so identified in one column (103). Dates associated with the items are listed (105), and persons of significance in the investigation are also listed (106). Investigations in other occupational fields will involve different parameters.

From a set of items of evidence that have been documented on the data table (100) a user mentally develops a particular line of reasoning. During that reasoning, the user needs to know more than the name of the object, such as “Gordon murder” for the final item listed on the table. Clicking the Item name (108) signals the computer to image the dialog box (200) used to create the record of that item. The user then has available, in addition to the parametric values that are on the table, text data that are in the Description field (201) of that dialog box. The description field, although not displayed on a data table, is part of the record of a text data object, thus as retrievable for report purposes as are parametric values.

While studying the data table, the user may hypothesize alternate arguments based on hypothetical parametric values. Accessing individual records to edit parametric values interrupts perception of the data table and the relative position of the text data objects. This invention allows the user to edit parametric values in place (109), so the user's perception of the table is not interrupted by opening dialog boxes needed to perform editing. In addition, this uninterrupted perception of the table allows better apprehension of vertical movement on the table of text data objects, as may be caused by changes in parametric values. Automated re-sorting after editing, required to cause that movement, is described in U.S. Pat. No. 6,134,564 at FIG. 715.

To create and document a reasoned argument based on the listed items of evidence, or one of a set of hypothetical arguments, the user assigns a rational order to relevant items (107). As each numeral is entered and saved, the computer automatically re-sorts the data as previously described. Items to be ignored are either not assigned numbers by the user or are deleted from the table. The next step is documenting the argument as a single text document consisting of a series of descriptions along with selected parametric values. The present invention enables the user, with a simple drop-down table familiar to those skilled in the art, to select, in order, the desired parameters. The user then signals the computer to retrieve into a new editable text file the (1) item names, in the designated order (107), each followed by (2) the data from its description field (201), and (3) values of the selected parameters (102)-(106) in the order assigned by the user. The computer then images the text file, as a new type report that can be saved and further edited.

It will be apparent to those skilled in the art that the invention described herein increases the integrity of an investigation of any type of non-homogeneous text data objects. The descriptive text studied during the reasoning is copied exactly into a new document, thus eliminating transcription as a source of error. It will also be apparent that the present invention is not limited to the specific embodiments discussed above, and that various modifications can be made to this invention without departing from the spirit or scope of the invention.

The invention described herein, and those in previously cited U.S. Pat. Nos. 6,134,564 and 6,216,139 and the colorization techniques in pending patent application Ser. No. 10/443,364, have a common purpose. That purpose is to assist a user of a table of text data objects in interactively modeling the table, as with a piece of moist clay, close to the speed of thought and with a minimum of operations. That allows the maximum retention of perceived data in the user's short term memory. Reasoning regarding perceived data then occurs with greater use of the user's personal knowledge, intuition, and imagination. That cognitive process was named, by the present inventor, contextual data modeling in U.S. Pat. No. 6,216,139.

1. A method for using a computer system to assemble and display a text file consisting of the names and parametric values of selected parameters of an imaged list of text data objects, comprising:
a. designating the order of text data objects from which data will be retrieved;
b. selecting the parameters of said text data objects for which parametric values will be retrieved;
c. signaling the computer to create and display a text file consisting of the names of designated text data objects in which each text object name is followed by the names and values of selected parameters.

2. A dual method for editing text data objects listed on computer-produced data tables comprising:
a. clicking imaged parametric values to edit them in-place without accessing the record of the text data object and;
b. clicking the name of the text data object to access the record for editing.
